(19) United States
(12) Patent Application Publication
(10) Pub. No.: US 2012/0241432 A1
(43) Pub. Date: Sep. 27, 2012

(54) LOW-COST GAS SHIELDED FLUX-CORED WIRE WITH RECYCLED WELDING SLAG

(75) Inventors: ZHUOXIN LIN, Beijing (CN); Guodong Li, Beijing (CN); Li Hong, Beijing (CN); Hui Li, Beijing (CN)

(73) Assignee: BEIJING UNIVERSITY OF TECHNOLOGY, BEIJING (CN)

(21) Appl. No.: 13/418,157

(22) Filed: Mar. 12, 2012

(30) Foreign Application Priority Data
Mar. 21, 2011 (CN) 201110068043.X

(51) Int. Cl. B23K 35/362; B21B 1/00

(52) U.S. Cl. 219/145.22; 72/365.2

(57) ABSTRACT

A gas shielded flux-cored wire (FCW) comprises s steel sheath and core flux, in which recycled welding slag powder is used to partially replace the natural rutile. The core flux contains (by weight): 10-50% recycling welding slag powder, 10-45% TiO₂, 2-7% Si, 5-20% Mn, 0.5-5% Al—Mg (Al/Mg=1), 0-11.52% Na₂CO₃, 0-8.85% K₂CO₃, 0-10% MgO, 0.5-10% fluoride, and iron powder as balance. The recycling welding contains (by weight): TiO₂: 20-65%, MnO: 5%-15%, MgO: 5%-15%, SiO₂: 5%-15%, Fe₂O₃: 1%-10%, Al₂O₃: 1%-10%.

### CROSS-REFERENCE TO RELATED APPLICATION

This application claims priority benefit of China application serial No. 201110068043.X filed on Mar. 21, 2011. The entire content of the above-mentioned patent application is hereby incorporated by reference herein and made a part of the specification.

### FIELD OF THE INVENTION

The present invention belongs to welding engineering in the field of materials processing, which relates to materials for arc welding, and in particular to a flux composition of flux-cored wires for welding mild and low alloy steels with a gas-shielded process.

### BACKGROUND OF THE INVENTION

Gas shielded flux cored wire welding combines the advantage of electrode welding and solid wire welding, so it attains high efficiency and welding performance. It is widely used in the field of ship building, bridges, offshore platforms and other steel manufacturing processes. Gas shielded flux cored wire primarily utilizes natural rutile to improve weld bead appearance and arc stability. Usually the amount of added natural rutile comprises 20%-50% of the total mineral powder in the flux, so natural rutile is in great demand in the flux cored wire manufacturing industry. On the other hand, the flux cost is one of the most important factors influencing the price of flux-cored wire, therefore, if the rutile is partially replaced by welding slag, the cost of flux cored wire will be decreased greatly, and at the same time, the natural rutile will be saved.

The measures have been taken in world's main natural rutile reserves and production companies to limit the exploitation and export of natural rutile. A tendency has emerged in the natural rutile mining and processing enterprises to lower production output and increase the price of rutile. But the global flux cored wire production keeps increasing year by year. It is predicted that the consumption of flux cored wire by 2020 is 2-3 times its current output and it might cause a great demand for natural rutile in the future. The supply of natural rutile and its prices will directly affect the flux cored wire manufacturing cost and its price.

As one of the important components of flux-cored wire, natural rutile has a great influence on the quality of welding, such as mechanical properties, arc stability and weld bead appearance, so the majority of manufacturers are using high quality natural rutile with purity above 92% and calcination. According to statistics, the price of 92% purity natural rutile is ⅓ more than that of 87% purity natural rutile.

### SUMMARY OF THE INVENTION

Welding slag is a feasible alternative to replace natural rutile because it has advantages over natural rutile in the welding process, as well as improving the mechanical properties of flux-cored wire, and can play a unique role compared to natural rutile. Generally after welding, a 100 g of flux-cored wire produces 11 g-15 g of welding slag. The welding slag powder has a more than 90% utilization rate after processing.

This processing contain the following steps: collecting weld slag, coarse screening, coarse grinding, magnetic separation and fine grinding. The welding slag containing compound TiO₂ can be reused, significantly reducing the dependence on natural rutile, and its effect in welding is equivalent to nature rutile. The cost of natural rutile is about $800/ton in 2010, but $1,700/ton in 2011, while the cost of welding slag powder recycling, processing, labor costs, energy consumption, machine wear, etc. is less than $200/ton, as shown in Table1. Thus using welding slag to replace natural rutile can greatly reduce the cost of FCW production and save resources.

TABLE 1
The processing cost of welding slag powder( [symbol] (RMB)/ton)

| Working | Collecting | | Coarse | Magnetic | Fine | | |
|---|---|---|---|---|---|---|---|
| procedure | slag | Coarse mesh | grinding | separation | grinding | Others | Total |
| Machine | 3 | 5 | 8 | 3 | 10 | | |
| wear | | | | | | | |
| Labor cost | 120 | 60 | 60 | 60 | 120 | 200 | |
| Energy | 20 | 40 | 50 | 40 | 80 | | |
| compusition | | | | | | | |
| Total | 123 | 105 | 118 | 103 | 210 | 200 | 859 |

Welding slag powder not only can act as an alternative to natural rutile but also can be recycled, thus it achieves a saving in resources, and the flux-cored wire made by welding slag powder becomes a green environmentally friendly welding consumable.

The purpose of the present invention is to use welding slag powder to replace the natural rutile, to reduce the cost and to increase the quality of flux-cored wire, thus it can decrease the dependence on natural rutile. Meanwhile, welding slag has some characteristics which compare favorably with natural rutile. Flux-cored wire using such a welding slag powder shows a more satisfying weld bead appearance, better welding operative performance, more excellent all-position welding adaptability, lower diffusible hydrogen content, better crack resistance, excellent impact toughness at low temperature than that of tradition flux-cored wire.

The welding slag that can be used in the present invention includes the welding slag of titanium oxide containing welding wire, such as titanium oxide type gas shielded flux-cored wire which contains natural rutile.

The flux-cored wire of the present invention can be used for welding mild steel and low alloy steel with a gas-shielded process and other similar metal materials. The term “mild steel” as used in the specification means carbon steel with the content of carbon less than 0.25%, “low alloy steel” means the steel in which the content of alloy element is less than 5%.

The slag powder can be manufactured in the following steps:

1) Collection of welding slag;

2) Coarse mesh: removing the dust of collected welding slag, and retaining the slag powder with size being bigger than 20 meshes;

3) Coarse grinding: crushing the obtained welding slag powder to obtain a coarse slag powder with king the size of less than 20 meshes;

4) Magnetic separation: removing the spatter mixed in the coarse slag powder;

5) Fine grinding: fine grinding the coarse slag powder to obtain a fine slag powder with the size in the range of 40-120 meshes.

The present invention provides low-cost gas shielded flux cored wire with the addition of recycling welding slag into flux. A low carbon steel strip is usually used as a metal sheath; the flux filling percent is about 12-18%, as described in the following chemical composition. The main components (weight %) include: 10-50% recycling welding slag powder, 10-45% TiO₂, 2-7% Si, 5-20% Mn, 0.5-5% Al—Mg (Al/Mg=1), 0-11.52% Na₂CO₃, 0-8.85% K₂CO₃, 0-10% MgO, 0.5-10% fluoride, and iron powder as the balance.

The present invention has no special requirements in production procedure. It can be performed by the manufacturing equipment and processes commonly used in the industry.

Flux-cored wires are manufactured with standard procedure in the following process. Low carbon steel strips (for example with width 10-14 mm, thickness 0.6-1.0 mm) are used to produce flux-cored wire.

First, the steel strip is rolled into a sheath with U-shaped cross section. Second, the flux is filled into the steel sheath. Finally, the steel sheath is rolled into a cylindrical shape and forms a lap joint, and the flux is contained in the cylindrical sheath as shown in FIG. 1.

For a certain length of flux-cored welding wire:

Filling percent=[(weight of flux)/(weight of flux+weight of steel sheath)]×100%.

### Role of Each Component is as Follows:

Welding slag: the reused welding slag which partially replaces the natural rutile is the main component in the flux to form welding slag. It can improve the welding slag coverage performance and slag detachability. After a high temperature melting process, welding slag powder is more uniform in physical and chemical properties. The welding slag powder has superior fluidity compared to natural rutile and the slag boundary is more clearly defined. Thus the flux-cored wires produce a more uniform weld appearance and enhance all-position welding operative properties. Gases more easily escape from the liquid deposited metal, while welding slag powder is resists moisture absorption compared with natural rutile. In addition, the diffusible hydrogen content in the deposited metal is reduced.

The other elements in the flux have the following effects:

Mn: Ensure the strength and reduce the oxygen content of the weld metal, reduce oxide inclusions and improve the impact toughness in the weld.

Si: Ensure the weld metal strength and reduce the oxygen content. If the content is too high, the viscosity of the deposited metal becomes larger, which reduces the adaptive welding property.

TiO₂: Stabilize the arc and increase toughness of deposited metal. It can also form a hydrogen traps to reduce diffusible hydrogen content in the deposited weld, thus reducing sensitivity of cold crack.

Al—Mg: Main role is to reduce oxygen content in the deposited metal, improve slag melting point and all-position welding properties.

K—Na oxide: Main role of K—Na is to attain stable arc and lower spatter. Appropriate ratio of K—Na can make electric arc soft and stable, and reduce welding spatter to a very low level.

Fluoride: slag-forming constituents; reducing the tendency to form pores; improving the fluidity of slag.

Iron: balance of composition, improve the deposition efficiency

### The Effect of the Invention is:

1. After collecting welding slag, screening, grinding and other processes, the welding slag powder was prepared into a certain size. As long as the composition and the particle size of welding slag powder are within permissive range (60-120 mesh), the welding slag powder could be recycled several times, which significantly reduces the costs of flux-cored wire, saves resources, and reduces dependence on natural rutile.

2. Welding slag which undergoes a high-temperature melting and solidification process has good resistance to moisture absorption, so that it is not necessary to calcinate the welding slag before adding it to the flux and the water content of flux cored wire can be reduced by about 50-70%. The diffusible hydrogen content in the deposited metal is decreased by more than 20%, which significantly reduces the crack sensitivity of the weld.

3. Using welding slag powder not only reduces the cost of flux core wire but also improves the slag fluidity and produces a more well-defined slag boundary in comparison with natural rutile. It yields a more appealing weld appearance and all-position welding operative performance with gas more easily escaping from weld deposited metal.

4. Flux-cored wire made in this way shows good arc stability, a purer weld pool, and presents excellent low-temperature impact toughness.

5. Adding aluminum and magnesium enables to reduce oxygen content and improve the low-temperature impact toughness of weld metal.

### BRIEF DESCRIPTION OF DRAWING

FIG. 1 illustrates the process of manufacturing a flux-cored welding wire according to an embodiment of the present invention.

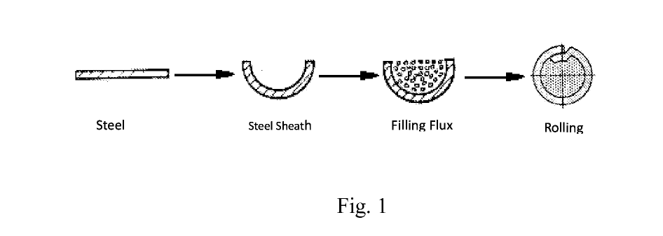

### EMBODIMENTS

Flux-cored wires (FCW) are manufactured with standard procedure in the following process, and subjected to welding tests. Low carbon steel strips (width 10-14 mm, thickness 0.6-1.0 mm) are used to produce flux-cored wire. Its typical chemical composition is shown in Table2.

TABLE 2
Chemical composition of the low carbon steel strip (weight %)

| C | Si | Mn | S | P |
|---|---|---|---|---|
| 0.03-0.06 | 0-0.02 | 0.10-0.15 | 0.015 | 0.015 |

### Example 1

FCW1 The chemical composition of the flux (weight %) is: welding slag powder of E71T-1 flux-cored wire: 10% (TiO₂: 65%, MnO: 15%, MgO: 5%, SiO₂: 5%, Fe₂O₃: 6%, Al₂O₃: 4%), natural rutile (purity 92%): 38.1%, Si:7%, Mn:20%, Al—Mg:0.5%, Na₂CO₃:11.52%, K₂CO₃:0%, MgO:1%, fluoride:0.5%, the rest is iron, filling percent is 12%.

FCW2 Collect the welding slag of FCW1 and reuse it, the chemical composition of the flux (weight %) is: welding slag powder: 28% (TiO₂: 52%, MnO: 12%, MgO: 8%, SiO₂: 9%, Fe₂O₃: 12%, Al₂O₃: 7%), natural rutile (purity 92%): 31.6%, Si: 7%, Mn: 6%, Al—Mg: 3%, Na₂CO₃: 10%, MgO: 10%, the rest is iron, filling percent is 16%.

FCW3 Collect the welding slag of FCW 2 and reuse it, the chemical composition of the flux (weight %) is: welding slag powder: 20% (TiO₂: 40%, MnO: 13%, MgO: 12%, SiO₂: 14%, Fe₂O₃: 11%, Al₂O₃: 10%), natural rutile (purity 92%): 21%, Si: 7%, Mn: 6%, Al—Mg: 5%, Na₂CO₃: 11.52%, MgO: 3%, the rest is iron, filling percent is 16%.

### Example 2

FCW4 The chemical composition of the flux (weight %) is: welding slag powder of E81T-1K2 flux-cored wire: 35% (TiO₂: 35%, MnO: 5%, MgO: 15%, SiO₂: 15%, Fe₂O₃: 15%, Al₂O₃: 15%), natural rutile (purity 92%): 16.3%, Si: 2%, Mn: 6%, Al—Mg: 5%, K₂CO₃: 8.85%, MgO: 1%, fluoride: 6%, the rest is iron, filling percent is 18%.

FCW5 Collect the slag of FCW 4 and reused it, the chemical composition of the flux (weight %) is: welding slag powder: 26% (TiO₂: 47%, MnO: 14%, MgO: 9%, SiO₂: 12%, Fe₂O₃: 8%, Al₂O₃: 10%), natural rutile (purity 92%): 23.2%, Si: 2%, Mn: 7%, Al—Mg: 4%, K₂CO₃: 8.52%, MgO: 1%, the rest is iron, filling percent is 17%.

### Example 3

FCW6 The chemical composition of the flux (weight %) is: welding slag powder of E91T-1K2 flux-cored wire: 30% (TiO₂: 55%, MnO: 10%, MgO: 12%, SiO₂: 12%, Fe₂O₃: 5%, Al₂O₃: 6%), natural rutile (purity 92%): 21%, Si: 6%, Mn: 5%, Al—Mg: 4%, K₂CO₃: 7%, MgO: 3%, fluoride:1%, the rest is iron, filling percent is 14%.

### Example 4

FCW7 The chemical composition of the flux (weight %) is: welding slag powder of E110T-1K3 flux-cored wire: 45% (TiO₂: 48%, MnO: 12%, MgO: 11%, SiO₂: 7%, Fe₂O₃: 9%, Al₂O₃: 13%), natural rutile (purity 92%): 10%, Si: 2%, Mn: 5%, Al—Mg: 5%, Na₂CO₃: 7.2%, MgO:1%, the rest is iron, filling percent is 15%.

### Example 5

FCW8 The chemical composition of the flux (weight %) is: welding slag powder of E71T-1 flux-cored wire: 20% (TiO₂: 45%, MnO: 5%, MgO: 12%, SiO₂: 9%, Fe₂O₃: 13%, Al₂O₃: 13%), natural rutile (purity 92%): 35%, Si: 3%, Mn:5%, Al—Mg: 5%, Na₂CO₃: 9.22%, MgO: 5%, fluoride: 8%, the rest is iron, filling percent is 13%.

### Example 6

FCW9 The chemical composition of the flux (weight %) is: welding slag powder of E71T-1 flux-cored wire: 40% (TiO₂: 65%, MnO: 15%, MgO: 5%, SiO₂: 5%, Fe₂O₃: 2%, Al₂O₃: 8%), natural rutile (purity 92%): 21.7%, Si: 7%, Mn: 8%, Al—Mg: 1%, K₂CO₃: 7.1%, MgO: 1%, fluoride:5%, the rest is iron, filling percent is 17%.

### Example 7

FCW10 The chemical composition of the flux (weight %) is: welding slag powder of E71T-1 flux-cored wire: 50% (TiO₂: 49%, MnO: 11%, MgO: 12%, SiO₂: 15%, Fe₂O₃: 11%, Al₂O₃: 2%), natural rutile (purity 92%): 10%, Si: 5%, Mn: 7%, Al—Mg: 2%, K₂CO₃: 3.5%, Na₂CO₃: 1%, MgO: 2%, the rest is iron, filling percent is 15%.

### Example 8

FCW11 The chemical composition of the flux (weight %) is: welding slag powder of E71T-1 flux-cored wire: 25% (TiO₂: 50%, MnO: 7%, MgO: 8%, SiO₂: 13%, Fe₂O₃: 11%, Al₂O₃: 11%), natural rutile (purity 92%): 38.0%, Si: 3%, Mn: 8%, Al—Mg: 2%, Na₂CO₃: 6.9%, MgO: 10%, fluoride:1%, the rest is iron, filling percent is 14%.

### Example 9

FCW12 The chemical composition of the flux (weight %) is: welding slag powder of E71T-1 flux-cored wire: 35% (TiO₂: 65%, MnO: 7%, MgO: 13%, SiO₂: 7%, Fe₂O₃: 4%, Al₂O₃: 4%), natural rutile (purity 92%): 27.2%, Si: 6%, Mn: 5%, Al—Mg: 5%, K₂CO₃: 5.3%, MgO: 5%, the rest is iron, filling percent is 16%.

### Example 10

FCW13 The chemical composition of the flux (weight %) is: welding slag powder of E71T-1 flux-cored wire: 28% (TiO₂: 55%, MnO: 13%, MgO: 7%, SiO₂: 10%, Fe₂O₃: 8%, Al₂O₃: 7%), natural rutile (purity 92%): 32.6%, Si: 5%, Mn: 6%, Al—Mg: 3%, Na₂CO₃: 6%, MgO: 3%, the rest is iron, filling percent is 15%.

### Example 11

### Contrast Test

FCW14 The chemical composition of the flux (weight %) is: natural rutile (purity 92%): 45%, Si:4%, Mn:7%, Al—Mg: 3%, Na₂CO₃: 11%, MgO: 3%, the rest is iron, filling percent is 13%. The welding slag was not added in this flux cored wire.

The water content in the flux of the FCW1-FCW14 are shown in Table6

Flux-cored wires above were made and welding tests were performed, and the crack rate of the deposited metal was measured according the standard of Y-Slit Type Cracking Test, as shown in Table3. The welding parameter is as flows: Welding current 260 A, Welding voltage 29V, Welding speed 25 cm/min, the shielding gas flow rate is 20 L/min, the interlayer-temperature is 100-170° C.

The chemical composition of the weld deposited metal is shown in Table4. According to AWS A5.29, the mechanical properties of the deposited metal result are shown in Table5. The operative performance of flux cored wire is shown in Table7.

TABLE 3
Test result of crack rate (%)

| | FCW | | | | | | | | | | | | | |
|---|---|---|---|---|---|---|---|---|---|---|---|---|---|---|
| | 1 | 2 | 3 | 4 | 5 | 6 | 7 | 8 | 9 | 10 | 11 | 12 | 13 | 14 |
| Sur- | 22 | 0 | 35 | 40 | 0 | 11 | 19 | 25 | 0 | 0 | 0 | 7 | 15 | 62 |
| face | | | | | | | | | | | | | | |
| Root | 36 | 17 | 55 | 67 | 47 | 85 | 75 | 65 | 85 | 80 | 45 | 55 | 0 | 85 |
| Cross | 10 | 43 | 10 | 10 | 92 | 10 | 10 | 10 | 10 | 10 | 82 | 95 | 0 | 10 |

TABLE 4
Chemical composition of the weld deposited metal (%)

| FCW | C | S | P | Si | Mn | Ni | Cr | Mo | V | Cu | Ti | Al |
|---|---|---|---|---|---|---|---|---|---|---|---|---|
| 1 | 0.051 | 0.007 | 0.016 | 0.43 | 1.39 | 0.01 | 0.04 | 0.01 | 0.02 | 0.02 | 0.051 | 0.01 |
| 2 | 0.042 | 0.007 | 0.012 | 0.45 | 1.42 | 0.01 | 0.02 | 0.03 | 0.01 | 0.02 | 0.04 | 0.035 |
| 3 | 0.048 | 0.012 | 0.015 | 0.42 | 1.38 | 0.01 | 0.02 | 0.03 | 0.01 | 0.01 | 0.057 | 0.007 |
| 4 | 0.050 | 0.007 | 0.014 | 0.39 | 1.33 | 0.01 | 0.04 | 0.01 | 0.02 | 0.02 | 0.051 | 0.01 |
| 5 | 0.042 | 0.010 | 0.015 | 0.49 | 1.44 | 0.01 | 0.02 | 0.02 | 0.01 | 0.01 | 0.057 | 0.009 |
| 6 | 0.047 | 0.010 | 0.011 | 0.47 | 1.51 | 0.01 | 0.02 | 0.02 | 0.01 | 0.01 | 0.057 | 0.009 |
| 7 | 0.045 | 0.010 | 0.012 | 0.40 | 1.39 | 0.01 | 0.02 | 0.02 | 0.01 | 0.01 | 0.057 | 0.009 |
| 8 | 0.040 | 0.010 | 0.010 | 0.42 | 1.46 | 0.01 | 0.02 | 0.02 | 0.01 | 0.01 | 0.057 | 0.009 |
| 9 | 0.048 | 0.012 | 0.015 | 0.42 | 1.38 | 0.01 | 0.02 | 0.03 | 0.01 | 0.01 | 0.057 | 0.007 |
| 10 | 0.050 | 0.007 | 0.014 | 0.39 | 1.33 | 0.01 | 0.04 | 0.01 | 0.02 | 0.02 | 0.051 | 0.01 |
| 11 | 0.044 | 0.006 | 0.013 | 0.49 | 1.44 | 0.01 | 0.02 | 0.02 | 0.01 | 0.01 | 0.057 | 0.009 |
| 12 | 0.046 | 0.009 | 0.010 | 0.42 | 1.42 | 0.01 | 0.02 | 0.02 | 0.01 | 0.01 | 0.053 | 0.009 |
| 13 | 0.045 | 0.008 | 0.012 | 0.44 | 1.39 | 0.01 | 0.02 | 0.02 | 0.01 | 0.01 | 0.049 | 0.008 |
| 14 | 0.040 | 0.010 | 0.010 | 0.49 | 1.451 | 0.01 | 0.02 | 0.02 | 0.01 | 0.01 | 0.052 | 0.009 |

TABLE 5
Mechanical properties of the weld deposited metal

| | | Yield | | | Impact | Impact | Impact |
|---|---|---|---|---|---|---|---|
| | Tensile | σ_{0.2} | Elongation | [H_{D}] | (−20° C.) | (−40° C.) | (−60° C.) |
| FCW | σ_{b} (MPa) | (MPa) | Δ₅ (%) | (ml/100 g) | Aₖᵥ(J) | Aₖᵥ(J) | Aₖᵥ(J) |
| 1 | 560 | 480 | 26.5 | 4.50 | 117 | — | — |
| 2 | 590 | 520 | 27 | 3.91 | 126 | — | — |
| 3 | 540 | 480 | 26.5 | 4.50 | 133 | — | — |
| 4 | 565 | 475 | 27 | 4.11 | — | — | 122 |
| 5 | 545 | 440 | 27 | 4.41 | — | — | 119 |
| 6 | 540 | 460 | 28 | 5.08 | — | — | 117 |
| 7 | 520 | 420 | 26 | 4.75 | — | 122 | — |
| 8 | 525 | 445 | 26 | 5.55 | 117 | — | — |
| 9 | 540 | 480 | 26.5 | 4.50 | 133 | — | — |
| 10 | 565 | 475 | 27.5 | 5.20 | 122 | — | — |
| 11 | 545 | 460 | 27 | 4.11 | 129 | — | — |
| 12 | 540 | 470 | 28 | 4.08 | 131 | — | — |
| 13 | 560 | 455 | 28 | 3.22 | 141 | — | — |
| 14 | 525 | 445 | 26 | 6.22 | 112 | — | — |

TABLE 6
Water content of the flux (100° C./%)

| | FCW | | | | | | | | | | | | | |
|---|---|---|---|---|---|---|---|---|---|---|---|---|---|---|
| | 1# | 2# | 3# | 4# | 5# | 6# | 7# | 8# | 9# | 10# | 11# | 12# | 13# | 14# |
| Water | 0.27 | 0.21 | 0.30 | 0.24 | 0.35 | 0.33 | 0.25 | 0.35 | 0.33 | 0.39 | 0.41 | 0.35 | 0.22 | 0.85 |
| content | | | | | | | | | | | | | | |

TABLE 7
Benchmark of operative performance (A > B > C > D)

| | Slag | | | Spatter | | All- |
|---|---|---|---|---|---|---|
| | detachability | Weld | Fume | rate | Arc | position |
| FCW | (%) | appearance | rate | (g/100 g) | stability | welding |
| 1 | 92 | A | 0.221 | 0.883 | A | A |
| 2 | 87 | B | 0.274 | 0.812 | B | A |
| 3 | 100 | A | 0.163 | 0.691 | B | B |
| 4 | 100 | A | 0.194 | 0.771 | B | B |
| 5 | 92 | B | 0.224 | 0.663 | B | B |
| 6 | 100 | A | 0.192 | 0.741 | A | B |
| 7 | 88 | B | 0.255 | 0.602 | B | A |
| 8 | 91 | A | 0.322 | 0.665 | A | B |
| 9 | 100 | A | 0.263 | 0.741 | B | B |
| 10 | 100 | A | 0.194 | 0.682 | B | B |
| 11 | 92 | A | 0.224 | 0.654 | B | A |
| 12 | 100 | A | 0.192 | 0.551 | A | B |
| 13 | 100 | A | 0.125 | 0.557 | A | A |
| 14 | 81 | B | 0.322 | 0.993 | B | B |

A: excellent
B: good
C: acceptable
D: unacceptable

While the preferred embodiments of the invention have been described above, it will be recognized and understood that various modifications may be made therein and the appended claims are intended to cover all such modifications that may fall within the spirit and scope of the invention.

What is claimed is:

1. A flux-cored wire for mild steels and low alloy steels with a filling percent of 12-18% comprising a steel sheath and core flux filled in the steel sheath, wherein
the core flux comprises (weight %): 10-50% recycled welding slag powder of a gas shielded flux-cored wire, 10-45% TiO₂, 2-7% Si, 5-20% Mn, 0.5-5% Al—Mg (Al/Mg=1), 0-11.52% Na₂CO₃, 0-8.85% K₂CO₃, 0-10% MgO, 0.5-10% fluoride, with the remainder being iron powder,
the recycled welding slag powder comprises (weight %): TiO₂: 35-65%, MnO: 5%-15%, MgO: 5%-15%, SiO₂: 5%-15%, Fe₂O₃: 1%-15%, Al₂O₃: 1-15%, and has a size of 40-120 mesh.

2. The flux-core wire according to claim 1, wherein the filling percent is 13-17%, the core flux comprises (weight %): 20-35% recycled welding slag powder (TiO₂: 45-65%, MnO: 5%-15%, MgO: 5%-15%, SiO₂: 5%-15%, Fe₂O₃: 2%-13%, Al₂O₃: 2-13%), 20-35% TiO₂, 3-7% Si, 4-8% Mn, 1-5% Al—Mg (Al/Mg=1), 0-9.22% Na₂CO₃, 0-7.1% K₂CO₃, 1-5% MgO, 1-10% fluoride, with the remainder being iron powder.

3. The flux-core wire according to claim 1, wherein the filling percent is 14-16%, the core flux comprises (weight %): 25-35% recycled welding slag powder (TiO₂: 50-65%, MnO: 7%-13%, MgO: 7%-13%, SiO₂: 7%-13%, Fe₂O₃: 4%-11%, Al₂O₃: 4-11%), 20-35% TiO₂, 3-6% Si, 5-8% Mn, 2-5% Al—Mg (Al/Mg=1), 0-6.9% Na₂CO₃, 0-5.3% K₂CO₃, 2-5% MgO, 2-10% fluoride, with the remainder being iron powder.

4. The flux-core wire according to claim 1, wherein 10-50% (by weight) of the recycled welding slag powder of a gas shielded flux-cored wire is added to replace the natural rutile in the core flux of the flux-cored wire, and the resulting flux-core wire can be recycled and used many times as long as its composition and particle size meet the required standard.

5. Method for manufacturing flux-cored welding wire comprising:
providing a steel sheath with U-shaped cross section;
filling the core flux obtained according to claim 1 is into the steel sheath; and
rolling the steel sheath into a cylindrical shape, wherein the core flux is contained in the cylindrical sheath.
